(19) United States
(12) Patent Application Publication
(10) Pub. No.: US 2004/0008364 A1
(43) Pub. Date: Jan. 15, 2004

(54) Image processing apparatus and control method thereof

(75) Inventor: Eiji Ohara, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/464,560

(22) Filed: Jun. 19, 2003

(30) Foreign Application Priority Data
Jul. 11, 2002 (JP) 2002-203113

(51) Int. Cl. G06F 3/12; G06F 15/00; G06F 11/30; G06F 13/00

(52) U.S. Cl. 358/1.14; 358/1.2; 719/327

(57) ABSTRACT

The present invention provides an image processing apparatus and method thereof, which can assure prevention of image data forgery with a simple configuration of the apparatus regardless of whether or not driver software installed in a host computer has a forgery prevention function. An image processing apparatus 102, e.g., a copying machine capable of high-quality image copying and color copying, is connected to a host computer 101 through a LAN 103. When the image processing apparatus 102 inputs/outputs image data through driver software installed in the host computer 101, the apparatus 102 identifies an existence/absence of a forgery prevention function in the driver software. In accordance with the identified result, a resolution of the image data is restrained.

### FIELD OF THE INVENTION

The present invention relates to an image processing apparatus and control method thereof for appropriately controlling image data input/output to/from a host computer.

### BACKGROUND OF THE INVENTION

Recently, as copying machines become capable of color copying and producing high-quality images, there are concerns about forging documents that should not be copied, e.g., securities, paper money and so forth. In order to prevent forgery of such documents, various countermeasures have been taken, e.g., inserting digital watermark information in particular documents in advance, and if the digital watermark information is extracted during image processing of a copying machine or the like, performing modification processing on the output image. Furthermore, characteristic data of the particular documents is stored in a copying machine or the like in advance, and a characteristic of an inputted image signal is compared with the stored data, thereby determining an existence/absence of the particular documents. When the inputted document is determined as one of the particular documents, some kind of modification processing is performed on the output image.

A recent copying machine is connectable with a host computer, and generally comprises a scanner function for transferring image data to a host computer, and a printer function for printing transferred image data.

However, the aforementioned copying machine, comprising the scanner function and printer function, has a disadvantage of not being planned to prevent forgery of image data transmitted between the copy machine and a host computer, or a disadvantage of high cost because of the complicated processing for preventing forgery of image data even if planned. In order to solve this problem, it is possible to add a forgery prevention function to the driver software (device driver), e.g., a scanner driver, a printer driver or the like, for the case of transmitting/receiving image data to/from the host computer.

However, there is a case where a compatible driver supplied by a third party (hereinafter referred to as a clone driver) is used as the aforementioned driver software. In this case, since such driver software has no guarantee to be compatible with the forgery prevention function, the prevention of image data forgery cannot be assured.

### SUMMARY OF THE INVENTION

The present invention has been proposed to solve the conventional problems, and has as its object to provide an image processing apparatus and method thereof, which can assure prevention of image data forgery with a simple configuration of the apparatus regardless of whether or not driver software installed in a host computer has a forgery prevention function.

In order to solve the above problems and attain the object, the image processing apparatus according to the present invention provides an image processing apparatus comprising receiving means for receiving a control command related to processing of image data from an external apparatus, image processing means for processing the image data, identifying means for identifying whether or not driver software installed in the external apparatus has a forgery prevention function of image data and control means for controlling the image processing means to process the image data based on the control command in a case where it is identified that the driver software has a forgery prevention function, while controlling the image processing means to process the image data under a predetermined condition in a case where it is identified that the driver software does not have a forgery prevention function.

Moreover, the image processing apparatus according to the present invention is characterized by further comprising input means for inputting the image data from the external apparatus, or output means for outputting image data processed by the image processing means to the external apparatus.

Furthermore, the image processing apparatus according to the present invention provides an image processing apparatus comprising input means for inputting image data, receiving means for receiving a setting related to a resolution of the image data from an external apparatus, resolution conversion means for converting the resolution of the image data, identifying means for identifying whether or not driver software installed in the external apparatus has a forgery prevention function of image data and control means for controlling the resolution conversion means to perform resolution conversion of the image data based on the setting related to the resolution in a case where it is identified that the driver software has a forgery prevention function, while controlling the resolution conversion means to perform resolution conversion of the image data under a predetermined condition in a case where it is identified that the driver software does not have a forgery prevention function.

Furthermore, the image processing apparatus according to the present invention is characterized by further comprising output means for outputting the resolution-converted image data to the external apparatus.

Furthermore, the image processing apparatus according to the present invention is characterized in that the forgery prevention function is a function for preventing forgery by detecting specific digital watermark information in the image data, or a function for preventing forgery by calculating a similarity level between a characteristic obtained from the image data and a characteristic of a particular image set in advance.

Furthermore, the image processing apparatus according to the present invention is characterized in that the identifying means identifies an existence/absence of the forgery prevention function of image data by determining whether or not the driver software is a genuine driver software for the external apparatus.

Furthermore, the image processing apparatus according to the present invention is characterized in that the identifying means identifies an existence/absence of a forgery prevention function of image data based on version information of the driver software.

Furthermore, the image processing apparatus according to the present invention is characterized in that in a case where it is identified that the driver software does not have a forgery prevention function, the control means controls the image processing means to restrain an image quality of the image data.

Furthermore, the image processing apparatus according to the present invention is characterized in that the restraint of the image quality of the image data is a restraint of a resolution.

Furthermore, the image processing apparatus according to the present invention is characterized by further comprising display means for displaying a message of a restrained image quality of the image data.

Furthermore, the image processing apparatus according to the present invention is characterized by further comprising window display means for displaying a warning message on a window or printing means for printing the warning message, in a case where it is identified that the driver software does not have a forgery prevention function.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of a data processing system, to which an image processing apparatus according to the first embodiment of the present invention is applicable;

FIG. 2 is a block diagram showing a detailed configuration of an image processing apparatus 102 shown in FIG. 1;

FIG. 3 is a flowchart describing an operation procedure of each processing unit in the image processing apparatus 102;

FIG. 4 is a flowchart describing an operation procedure of an image processing apparatus according to the second embodiment of the present invention;

FIG. 5 is a side view showing a construction of a copying machine, which realizes an image processing apparatus according to the third embodiment of the present invention; and

FIG. 6 is a diagram showing a configuration of a data processing apparatus, which realizes an image processing apparatus according to the fourth embodiment of the present invention.

### DETAILED DESCRIPTION OF THE PREFERRED EMBODIMENTS

Preferred embodiments of the present invention will now be described in detail in accordance with the accompanying drawings.

<First Embodiment>

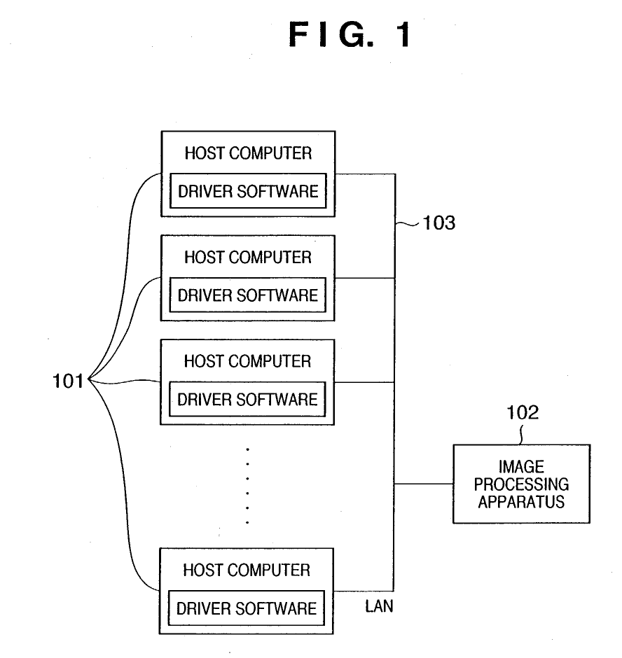

FIG. 1 is a block diagram showing an example of a data processing system, to which an image processing apparatus according to the first embodiment of the present invention is applicable. In FIG. 1, a plurality of host computers 101 are connected to an image processing apparatus 102 in a communicatable state using a predetermined protocol through a network, such as a LAN 103, and driver software installed in each of the host computers. In other words, the host computers 101 can command the image processing apparatus 102 to perform image data processing by performing predetermined communication with the image processing apparatus 102.

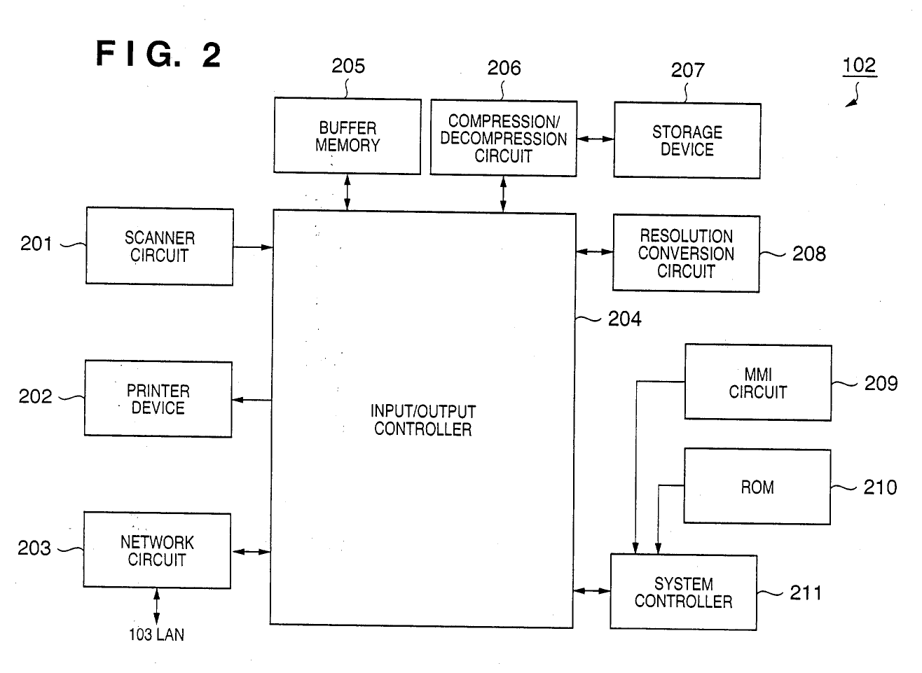

FIG. 2 is a block diagram showing a detailed configuration of the image processing apparatus 102 shown in FIG. 1. As shown in FIG. 2, the image processing apparatus 102 according to the first embodiment comprises: a scanner circuit 201, an input/output controller 204 to which an output of the scanner circuit 201 is supplied, a network circuit 203 connected to the input/output controller 204, buffer memory 205, a compression/decompression circuit 206, and a resolution conversion circuit 208. Further, a printer device 202 is connected to the input/output controller 204. To the network circuit 203, the host computers 101 are connected via the LAN 103. To the compression/decompression circuit 206, a storage device 207 is connected.

Moreover, the image processing apparatus 102 includes a man machine interface (MMI) circuit 209, ROM 210, and a system controller 211, to which respective outputs of the MMI circuit 209 and ROM 210 are supplied. Note that the system controller 211 is connected to the input/output controller 204.

Next, a series of operation in the image processing apparatus 102, having the above-described configuration, is described.

Image data obtained by the scanner circuit 201 or image data obtained through the network circuit 203 is inputted to the image processing apparatus 102. More specifically, the scanner circuit 201 supplies the input/output controller 204 with the image data read by scanning an original document. The network circuit 203 supplies the input/output controller 204 with bitmap image data, which has been developed from PDL (Page Description Language) data by the host computer 101. The network circuit 203 transmits/receives image data to/from the input/output controller 204, and performs bi-directional communication of image data with the host computers 101.

The input/output controller 204 controls image data reading/writing operation of the buffer memory 205, and controls image data reading/writing operation of the storage device 207 through the compression/decompression circuit 206. By the foregoing operation, the input/output controller 204 can store image data, supplied through the scanner circuit 201 or the network circuit 203, in the buffer memory 205 as well as the storage device 207, constructed with a magneto-optic disk (MO) drive or hard disk or the like, through the compression/decompression circuit 206.

The resolution conversion circuit 208 performs resolution conversion processing on image data, which is stored in the buffer memory 205 and supplied via the input/output controller 204, and transfers the resolution-converted image data back to the input/output controller 204. Then, the input/output controller 204 stores the resolution-converted image data in the buffer memory 205, and stores the resolution-converted image data in the storage device 207 through the compression/decompression circuit 206.

Meanwhile, the system controller 211, constructed with a CPU (central processing unit) or the like, performs operation control of the entire image processing apparatus 102 in accordance with a processing program stored in advance in the ROM 210 and various settings related to the image processing apparatus 102, which are set with the use of the MMI circuit 209, serving as an operation unit, or driver software installed in the host computers 101.

Particularly, the system controller 211 controls operation conditions of the input/output controller 204 by identifying information related to the driver software installed in the respective host computers shown in FIG. 1.

In accordance with the control of the system controller 211, the input/output controller 204 transmits the image data, stored in the storage device 207 as described above, through the compression/decompression circuit 206 to the printer device 202 for printing the image data. The printer device 202 prints out the image data supplied by the input/output controller 204. Alternatively, the input/output controller 204 transmits the image data, stored in the storage device 207, to the network circuit 203 through the compression/decompression circuit 206. The network circuit 203 transfers the image data, supplied by the input/output controller 204, to the host computers 101.

As described above, the present invention provides an image processing apparatus and control method thereof, which comprises an image processing unit, e.g., the scanner circuit 201, compression/decompression circuit 206, resolution conversion circuit 108, printer device 202 and the like, for processing image data. First, the network circuit 203 receives a control command related to image data processing from the host computer 101. Then, it is determined whether or not the driver software installed in the host computer 101 has an image data forgery prevention function. If it is determined that the driver software has a forgery prevention function, the system controller 211 causes the image processing unit to perform processing of the image data based on the control command. On the contrary, if it is determined that the driver software does not have a forgery prevention function, the system controller 211 causes the image processing unit to perform processing of the image data under a predetermined condition.

Furthermore, the image processing apparatus according to the present invention is characterized by comprising the network circuit 203 which inputs image data from the host computer 101, or outputs image data, processed by the above-described image processing unit, to the host computer 101.

Moreover, the present invention provides an image processing apparatus and control method thereof, which comprises the resolution conversion circuit 208 for converting a resolution of inputted image data. First, image data is inputted from the network circuit 203 or the scanner circuit 201. Then, a setting related to the resolution of the image data is received from the host computer 101. Then, it is determined whether or not the driver software installed in the host computer 101 has an image data forgery prevention function. As a result, if it is determined that the driver software has a forgery prevention function, the system controller 211 causes the resolution conversion circuit 208 to perform resolution conversion of the image data based on the setting related to the resolution. On the contrary, if it is determined that the driver software does not have a forgery prevention function, the system controller 211 causes the resolution conversion circuit 208 to perform resolution conversion of the image data under a predetermined condition.

Furthermore, the image processing apparatus according to the present invention is characterized by comprising the network circuit 203, which outputs the resolution-converted image data to the host computer 101.

Next, an operation procedure of the image processing apparatus 102, which is connected to the host computers 101 through the LAN 103, is described in detail.

As mentioned above, the image processing apparatus 102 is communicatable with the host computers 101 using a predetermined protocol. More specifically, data received from the host computer 101 through the network circuit 203 is supplied to the input/output controller 204, and the system controller 211 performs various control based on the received data. For instance, assume that various setting data related to a scanner operation of the image processing apparatus 102 is transmitted from the host computer 101. The system controller 211 performs controlling to execute various settings based on the received setting data. Alternatively, in a case where scanner start-up data is transmitted from the host computer 101, the system controller 211 performs controlling to start the scanner operation.

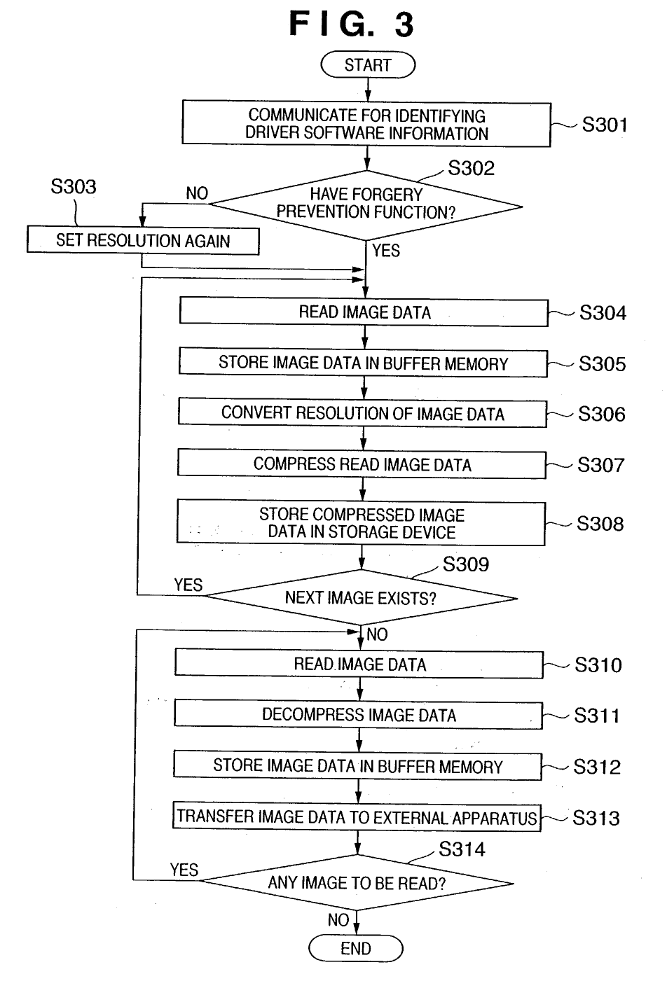

FIG. 3 is a flowchart describing an operation procedure of each processing unit in the image processing apparatus 102. Assume that a control program according to the flowchart shown in FIG. 3 is stored in advance in, e.g., the ROM 210 of the image processing apparatus 102. When a scanner operation is started as mentioned above, the control program stored in the ROM 210 is read and executed by the system controller 211. Note that the control program described in the flowchart in FIG. 3 is for realizing the scanner function. The scanner function is a part of the functions possessed by the image processing apparatus 102. The image processing apparatus 102 operates in the following manner.

When the control program described in the flowchart in FIG. 3 is read out of the ROM 210 and executed by the system controller 211, the system controller 211 communicates with the host computer 101 to acquire information related to a scanner driver installed in the host computer 101 (step S301).

Herein, the information related to the scanner driver includes data for identifying whether or not the scanner driver installed in the host computer 101 has a forgery prevention function. For instance, the information related to the scanner driver includes information about whether it is a genuine driver instead of a clone driver compatible with the image processing apparatus 102, or information about a version number of the driver software.

Based on the information related to the scanner driver acquired by the system controller 211, whether or not the scanner driver has a forgery prevention function is identified (step S302). As a result, if it is identified that the scanner driver has a forgery prevention function (YES), the system controller 211 outputs an image-data read command to, e.g., the scanner circuit 201, through the input/output controller 204. Then, the scanner circuit 201 reads an image of an original document (not shown) as digital image data (hereinafter referred to as image data) (step S304).

Meanwhile, if the system controller 211 identifies that the scanner driver does not have a forgery prevention function (NO), the system controller 211 cancels the setting related to the resolution of image data to be handled by the image processing apparatus 102, which is set by the host computer 101, and instead sets a relatively low resolution, which is set in advance on the image processing apparatus side (step S303). In other words, the image processing apparatus according to the present invention is characterized in that, in a case where it is determined that the driver scanner does not have a forgery prevention function, the system controller 211 controls the scanner circuit 201 or the resolution conversion circuit 208 to place restraint on the quality of the image data.

The image data read by the scanner circuit 201 in step S304 is stored in the buffer memory 205 by the controlling of the input/output controller 204 (step S305).

Next, the system controller 211 commands the input/output controller 204 such that resolution conversion is performed by the resolution conversion circuit 208 and the converted image data is stored in the storage device 207. The input/output controller 204 reads the image data out of the buffer memory 205, and causes the resolution conversion circuit 208 to convert resolution to achieve a predetermined resolution (step S306). The resolution-converted image data is stored again in the buffer memory 205, and supplied to the compression/decompression circuit 206.

The compression/decompression circuit 206 compresses the image data, supplied by the input/output controller 204, in accordance with a predetermined compression method (step S307). The image data compressed by the compression/decompression circuit 206 is stored in the storage device 207 (step S308).

Note that a part of the resolution conversion executed in step S306 may be realized by altering the reading speed of the scanner circuit 201.

Next, the system controller 211 determines through the input/output controller 204 whether or not the next image data is read and inputted by the scanner circuit 201 (step S309). For instance, assume that an automatic document conveyer (not shown) is connected to the scanner circuit 201, and a plurality of original documents are conveyed by the automatic document conveyer and images of the documents are read. In this case, the system controller 211 is able to determine whether or not there is a next original document by an output signal of a sensor or the like, sensing an original document placement on the automatic document conveyer.

If it is determined that there is a next original document (YES), the above-described controls are repeated from step S304. In this case, a plurality of image data is stored in the storage device 207. The addresses of the respective image data are managed by the system controller 211.

As described above, after all the image data read by the scanner circuit 201 is stored in the storage device 207, i.e., in a case where there is no more original document in step S309 (NO), the system controller 211 commands the input/output controller 204 to read the image data, stored in the storage device 207, and supplies the data to the buffer memory 205.

Based on the command, the input/output controller 204 controls a reading operation of the storage device 207, and supplies the compression/decompression circuit 206 with one of the image data, stored in the storage device 207, in order of storage (step S310). The compression/decompression circuit 206 decompresses the one of the image data, supplied by the storage device 207, in accordance with a predetermined decompression method (step S311). The image data, decompressed by the compression/decompression circuit 206, is supplied and stored in the buffer memory 205 by the controlling of the input/output controller 204 (step S312).

The system controller 211 commands the input/output controller 204 to transfer the decompressed image data, stored in the buffer memory, to a predetermined host computer 101, which serves as an external apparatus, through the network circuit 203 (step S313).

Next, the system controller 211 determines through the input/output controller 204 whether or not all the image data stored in the storage device 207 has been read and transferred to the predetermined host computer 101 (step S314).

As a result of the determination, if transferring of all the image data has not been completed, i.e., in a case where there is more image to be read (YES), the system controller 211 performs operation control to repeat the controls from step S310. In this manner, all the image data stored in the storage device 207 is read in order of storage and transferred to the predetermined host computer 101 serving as an external apparatus.

In the above-described first embodiment, image data is transferred to the host computer 101, serving as an external apparatus, through the network, e.g., LAN or the like. However, data transfer is not limited to this method, but other methods, e.g., utilizing a public telephone network through a modem or the like, may be employed.

Note that transferring image data to the host computer 101 may be performed after compressing the resolution-converted image data by the compression/decompression circuit 206. In this case, decompression is performed by the host computer 101. By virtue of the compression, the amount of data transferred to the host computer 101 can be reduced, thereby enabling to reduce the transferring time.

Note in the above-described processing, in a case where it is identified that the driver software installed in the host computer 101 does not have a forgery prevention function and the image quality of the image processing apparatus 102 is restrained, a warning message, advising a change of the driver software and informing the restrained image quality, may be displayed on a display device of the host computer 101 or image processing apparatus 102. Alternatively, a warning message may be printed out by the image processing apparatus 102.

As described above, the image processing apparatus according to the present invention is characterized by further comprising a display device for displaying a message of a restrained image quality. Moreover, the image processing apparatus is characterized by further comprising a display device for displaying a warning message, or a printing device for printing a warning message, in a case where it is identified that driver software does not have a forgery prevention function.

Hereinafter, the aforementioned forgery prevention function of the scanner driver installed in the host computer 101 is described in detail. The forgery prevention function in the host computer 101 determines whether or not the image data supplied to the host computer is a particular image based on whether or not the image data includes specific digital watermark information inserted in advance. If the image data is determined as the particular image, the image processing apparatus 102 performs modification processing, e.g., making changes in the image data, in a way that the image can be clearly recognized as the particular image, or deletes the image data. In other words, the forgery prevention function according to the present invention prevents forgery by detecting specific digital watermark information in image data, or calculating a similarity level between characteristics of input image data and characteristics of the particular image set in advance.

Next, a description is provided on determination processing of whether or not image data, supplied to the host computer 101, is a particular image based on whether or not the image data includes specific digital watermark information inserted in advance. Assume that image data (input image) is inputted from the scanner circuit 201.

The inputted image is divided into blocks, and Fourier transformation is performed on each of the blocks to extract a predetermined frequency component. The inputted image of the frequency area, obtained as a result of Fourier transformation, is separated into an amplitude spectrum and a phase spectrum. A registration signal included in the amplitude spectrum is detected.

The registration signal has the following disadvantages. More specifically, embedding the signal in low-frequency components is more likely to be recognized as noise compared to embedding the signal in high-frequency components, because of the human visual characteristics. Furthermore, since irreversible compression methods, e.g., JPEG compression or the like, have an effect similar to a low-pass filter, high-frequency components are removed by the compression/decompression processing.

In view of the above disadvantages of high-frequency components and low-frequency components, the aforementioned registration signal is embedded as an impulse signal in a mid-level frequency having a level higher than a first frequency level that is not easily recognized by human perception, and lower than a second frequency level that is not removed by irreversible compression/decompression. Therefore, in the detection of the registration signal, an impulse signal having the above-described mid-level frequency is extracted from the amplitude spectrum.

Based on coordinates of the extracted impulse signal, a scaling factor of the inputted image is calculated. In the determination of digital watermark detection, a frequency component of the unscaled determination-target image, in which the impulse signal is embedded, is recognized in advance. The scaling factor can be calculated from the ratio between the recognized frequency and a frequency in which the impulse signal is detected. For instance, assuming that the recognized frequency is a and the frequency of the detected impulse signal is b, scaling is performed at a/b. This is a known nature of Fourier transformation.

As described above, the size of a pattern for detecting a digital watermark included in the inputted image is determined based on the scaling factor obtained from the ratio between two frequencies. Performing convolution using this pattern can detect a digital watermark included in the digital image data.

Note that a digital watermark may be added to any components constituting an input image. However, this embodiment assumes that the digital watermark is added to the blue component, to which human visual perception is the least sensitive, and that digital watermark detection using the above-described pattern is performed on the blue component.

Furthermore, instead of adding a digital watermark to visible color components constituting an input image, a digital watermark may be embedded in a specified frequency component of an input image. In such case, digital watermark detection is performed on the specified frequency after Fourier transformation is performed on the input image.

Note that the determination processing is not limited to the above-described one, but determination may be performed in accordance with another algorithm, which determines a similarity level between characteristics of input image data and characteristics of the particular image set in advance. In other words, any determination processing may be used as long as it can at least determine whether or not an input image is a particular image.

As described above, the image processing apparatus 102 according to the first embodiment performs predetermined processing, e.g., placing restraint on a resolution of inputted image data, in a case where driver software installed in a host computer does not have a forgery prevention function, thereby enabling to clearly distinguish between the input image and particular images. Accordingly, the prevention of forging particular images can be assured.

<Second Embodiment>

Next, an image processing apparatus according to the second embodiment of the present invention is described.

In the above-described first embodiment, image data read by the scanner circuit 201 is transferred to the host computer 101. In the second embodiment, image data transferred from the host computer 101 is printed by the printer device 202.

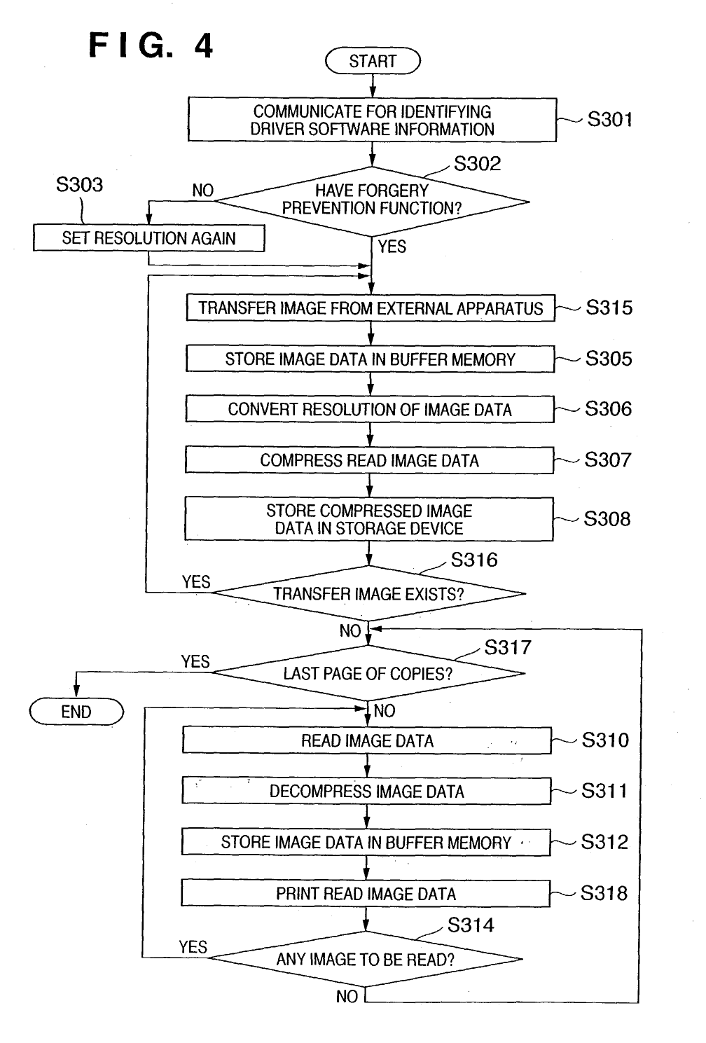

Note that the image processing apparatus according to the second embodiment is the same image processing apparatus according to the first embodiment, and detailed configuration thereof is shown in FIG. 2. In this embodiment, the control program stored in the ROM 210 realizes the control described in the flowchart in FIG. 4. FIG. 4 is a flowchart for describing an operation procedure of the image processing apparatus according to the second embodiment. The control program described in the flowchart in FIG. 4, which is stored in advance in the ROM 210, is also read and executed by the system controller 211.

In the control program described in the flowchart in FIG. 4, with respect to the control steps similar to those in the flowchart in FIG. 3, the same reference numerals are assigned and detailed description thereof is omitted. Furthermore, in the second embodiment, the detailed configuration of the image processing apparatus, which is operated as a result of executing the control program stored in the ROM 210, is identical to that of the image processing apparatus 102 shown in FIG. 2. Therefore, a description thereof is omitted.

Hereinafter, features that are different from the above-described first embodiment are described in detail.

First, the control program described in the flowchart in FIG. 4 is read out of the ROM 210 and executed by the system controller 211. The system controller 211 communicates with the host computer 101 to acquire information related to a printer driver installed in the host computer 101 (step S301).

Herein, the information related to the printer driver includes data for identifying whether or not the printer driver installed in the host computer 101 has a forgery prevention function. For instance, the information related to the printer driver includes information about whether it is a genuine driver software instead of a clone driver compatible with the image processing apparatus 102, or information about a version number of the driver software.

As described above, the image processing apparatus according to the present invention is characterized in that an existence/absence of an image data forgery prevention function is identified by determining whether or not driver software installed in the host computer 101 is genuine driver software for the host computer 101. Furthermore, the image processing apparatus is characterized in that an existence/absence of an image data forgery prevention function is identified based on version information of the driver software.

Then, the system controller 211 identifies whether or not the printer driver has a forgery prevention function (step S302). As a result, if it is identified that the printer driver has a forgery prevention function (YES), the system controller 211 outputs an image-data transfer command to the host computer 101 through the network circuit 203. Then, image data generated in the host computer 101 is transferred to the network circuit 203 by general-purpose protocol control, e.g., SCSI (Small Computer System Interface), TCP/IP (Transmission Control Protocol/Internet Protocol), and the like (step S315).

Meanwhile, if the system controller 211 identifies that the printer driver does not have a forgery prevention function (NO), the system controller 211 cancels the setting related to the resolution of image data to be handled by the image processing apparatus 102, which is set by the host computer 101, and instead sets a relatively low resolution, which is set in advance on the image processing apparatus side (step S303).

The image data transferred to the network circuit 203 in step S315 is stored in the buffer memory 205 by the controlling of the input/output controller 204 (step S305).

Next, the system controller 211 commands the input/output controller 204 such that resolution conversion is performed by the resolution conversion circuit 208 and the converted image data is stored in the storage device 207. The input/output controller 204 reads the image data out of the buffer memory 205, and causes the resolution conversion circuit 208 to convert resolution to achieve a predetermined resolution (step S306). The resolution-converted image data is stored again in the buffer memory 205, and supplied to the compression/decompression circuit 206. The compression/decompression circuit 206 compresses the image data, supplied by the input/output controller 204, in accordance with a predetermined compression method (step S307). The compressed image data is stored in the storage device 207 (step S308).

Next, the system controller 211 determines through the input/output controller 204 whether or not the next image data is transferred from the host computer 101 (step S316). As a result, if it is determined that there is a next image data transfer (YES), the above-described controls are repeated from step S315. In this case, a plurality of image data is stored in the storage device 207. The addresses of the respective image data are managed by the system controller 211.

Next, the system controller recognizes the number of copies to be printed set by, e.g., the printer driver software of the host computer 101, and determines whether or not the printing device 202 has completed printing for the set number of copies (step S317). As a result, if the printing for the last page of the copies has not been completed (NO), the system controller 211 commands the input/output controller 204 to read the image data stored in the storage device 207. Based on the command, the input/output controller 204 controls a reading operation of the storage device 207, and supplies the compression/decompression circuit 206 with one of the image data, stored in the storage device 207, in order of storage (step S310).

The compression/decompression circuit 206 decompresses the image data, supplied by the storage device 207, in accordance with a predetermined decompression method (step S311). The image data, decompressed by the compression/decompression circuit 206 in step S311, is stored in the buffer memory 205 by the controlling of the input/output controller 204 (step S312). Furthermore, the system controller 211 commands the input/output controller 204 to perform printing by the printer device 202. The input/output controller 204 reads the image data, stored in the buffer memory 205 in step S312, and supplies the data to the printer device 202. The printer device 202 prints the image data supplied by the input/output controller 204 (step S318).

Next, the system controller 211 determines through the input/output controller 204 whether or not all the image data stored in the storage device 207 has been read and printed out, i.e., whether or not there is more image to be read (step S314). As a result of the determination, if printing of all the image data has not been completed, i.e., in a case where there is more image to be read (YES), the system controller 211 performs operation control to repeat the controls from step S310. In this manner, all the image data stored in the storage device 207 is read in order of storage and printed by the printer device 202.

After printing of all the image data stored in the storage device 207 is completed, the system controller 211 recognizes the result of determination in step S314, and returns to the determination processing in step S317 where it is determined whether or not printing for the last page of the copies has been completed. When the system controller 211 determines in step S317 that printing for the last page of the copies has been completed (YES), the control ends.

In a case of printing only one copy, the controls shown in steps S310 to S314 are repeated for the number of image data stored in the storage device 207. The image data is read out of the storage device 207 in order of storage, and sequentially printed by the printer device 202.

<Third Embodiment>

Next, an image processing apparatus according to the third embodiment of the present invention is described.

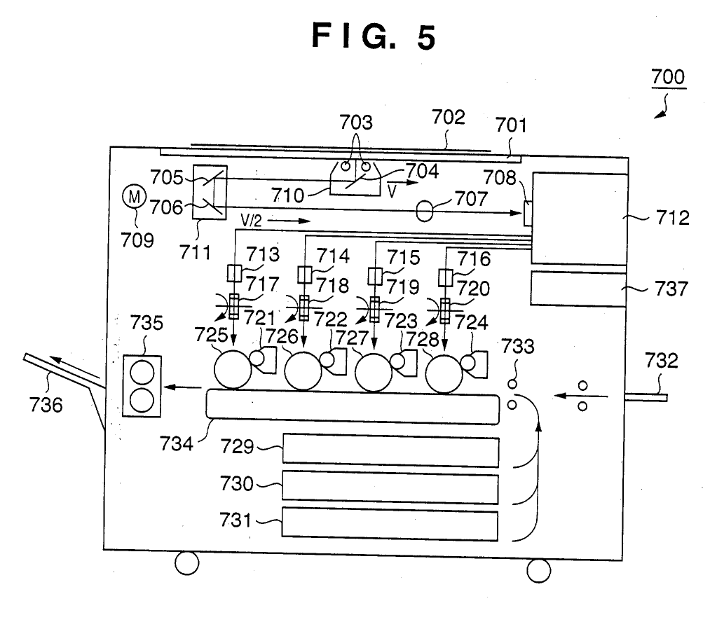

The image processing apparatus according to the third embodiment is realized by, e.g., a color copying machine 700 shown in FIG. 5. FIG. 5 is a side view showing a construction of a copying machine, which realizes the image processing apparatus according to the third embodiment. The color copying machine 700 shown in FIG. 5. comprises: an original glass plate 701 where an original document 702 to be read is placed; a lamp 703 provided for illuminating the original document 702 placed on the original glass plate 701; an optical system 707; mirrors 704 to 706 for directing light from the original document 702 to the optical system 707; an image sensing device 708 where the light from the optical system 707 forms an image; a motor 709 for respectively driving a first mirror unit 710, including the mirror 704 and the lamp 703, and a second mirror unit 711, including the mirrors 705 and 706; an image processor 712 to which an output of the image sensing device 708 is supplied; semiconductor lasers 713 to 716 to which an output of the image processor 712 is supplied; polygon mirrors 717 to 720 to which outputs of the respective semiconductor lasers 713 to 716 are supplied; photosensitive drums 725 to 728 to which outputs of the respective polygon mirrors 717 to 720 are supplied; developers 721 to 724 for supplying toner to the photosensitive drums 725 to 728; paper trays 729 to 731; a manual-feed tray 732; a transfer belt 734; resist rollers 733 for introducing a paper sheet fed from the paper trays 729 to 731 or manual-feed tray 732 to the transfer belt 734; a fixing unit 735 for fixing the toner, transferred by the photosensitive drums 725 to 728, on the paper sheet on the transfer belt; a paper discharge tray 736 for discharging the paper sheet, on which the toner is fixed by the fixing unit 735; and a network circuit 737 for transmitting/receiving data to/from an external apparatus through a LAN.

The above-described color copying machine 700 comprises the function of the image processing apparatus 102 shown in FIG. 2, which is described in the first and second embodiments. The original document plate 701, lamp 703, optical system 707, image sensing device 708, first mirror unit 710, second mirror unit 711, and motor 709 are an image-reading unit, which corresponds to the scanner circuit 201 in FIG. 2.

Furthermore, the image processor 712 is a unit for outputting an image signal subjected to printing, and corresponds to the input/output controller 204, storage device 207, buffer memory 205, compression/decompression circuit 206, resolution conversion circuit 208, and system controller 211 shown in FIG. 2. Furthermore, the semiconductor lasers 713 to 716, polygon mirrors 717 to 720, photosensitive drums 725 to 728, paper trays 729 to 731, manual-feed tray 732, transfer belt 734, resist rollers 733, fixing unit 735, and paper discharge tray 736 are a unit for printing out an image, and correspond to the printer device 202 in FIG. 2. Moreover, the network circuit 737 corresponds to the network circuit 203 in FIG. 2.

Next, an operation procedure of the color copying machine having the above-described construction is described.

First, the original document 702 subjected to reading is placed on the original glass plate 701. The original document 702 is irradiated by the lamp 703. Reflection light of the original document 702 goes through the mirrors 704, 705, and 706 sequentially, and an image is formed on the image sensing surface of the image sensing device 708 by the optical system 707.

At this stage, the motor 709 mechanically drives the first mirror unit 710, including the mirror 704 and lamp 703, at velocity V, and mechanically drives the second mirror unit 711, including the mirrors 705 and 706, at velocity V/2. Accordingly, the entire surface of the original document 702 is scanned.

The image sensing device 708, comprising a solid-state image sensing device (CCD: Charge Coupled Device) or the like, converts the image formed by the optical system 707 into an electric image signal using photoelectric transfer, and supplies the image processor 712 with the electric image signal.

The image processor 712 performs predetermined processing on the image signal from the image sensing device 708, and outputs a printing signal. The semiconductor lasers 713 to 716 are driven by the printing signal outputted by the image processor 712. Laser beams, emitted by the respective semiconductor lasers 713 to 716, form latent images on the photosensitive drums 725 to 728 by the polygon mirrors 717 to 720.

The developers 721 to 724 develop the latent images formed on the respective photosensitive drums 725 to 728, using toner having the colors of Bk (black), Y (yellow), C (cyan), and M (magenta). At this stage, a paper sheet fed from one of the paper trays 729 to.731 and the manual-feed tray 732 is transferred through the resist rollers 733 and conveyed while being attached to the transfer belt 734.

In synchronization with the paper-feed timing, toner images of respective colors are developed on the photosensitive drums 725 to 728. As the paper sheet is conveyed, the toner images of respective colors are transferred to the paper sheet. The paper sheet, to which the toner images are transferred, is separated from the transfer belt 734, conveyed to the fixing unit 735 where the toner images are fixed, and discharged from the paper discharge tray 736.

In a case where an image signal is transmitted to an external apparatus, the image signal outputted by the image processor 712 is transmitted to an external apparatus through the network circuit 737. In a case where an image signal is received, the image signal is inputted from an external apparatus to the image processor 712 through the network circuit 737. Furthermore, in a case of printing the received image signal, the received signal is outputted as a printing signal from the image processor 712.

<Fourth Embodiment>

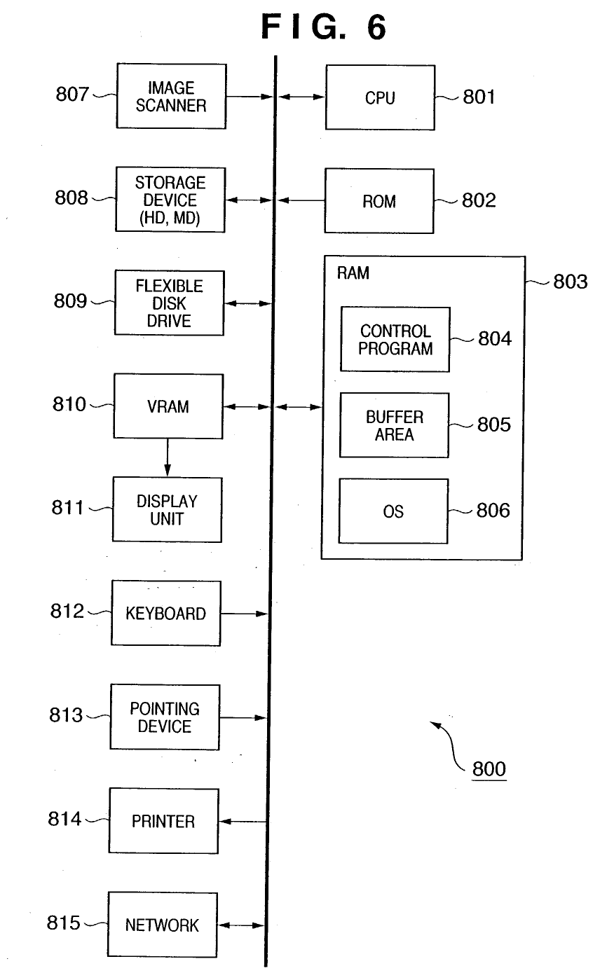

Next, the fourth embodiment of the present invention is described. An image processing apparatus according to the fourth embodiment of the present invention is realized by, e.g., a data processing apparatus 800 shown in FIG. 6. FIG. 6 is a diagram showing a configuration of the data processing apparatus, which realizes the image processing apparatus according to the fourth embodiment.

The data processing apparatus 800 shown in FIG. 6 comprises: a CPU 801, ROM 802, RAM 803, an image scanner 807, a storage device 808, a disk drive 809, VRAM 810, a display unit 811, a keyboard 812, a pointing device 813, a printer 814, and a network circuit 815, which are connected to each other through a bus 816 so as to mutually transmit/receive data.

The above-described data processing apparatus 800 comprises the function of the image processing apparatus 102 shown in FIG. 2, which is described in the first and second embodiments. More specifically, the CPU 801 controls the entire operation of the data processing apparatus 800. The CPU 801 corresponds to the input/output controller 204 and system controller 211 in FIG. 2. The ROM 802 stores a boot program, BIOS (Basic Input/Output System) and so forth in advance.

The RAM 803 is an area used as a work area of the CPU 801. Secured in the RAM 803 is an area for a control program 804 corresponding to a series of control procedures, a buffer area 805 used at the time of inputting or printing image data, and an area for an operating system (OS) 806, e.g., the control program 804, for performing an operation control of the entire data processing apparatus 800. The control program 804 stored in an executable form in the RAM 803, e.g., the control programs described in the flowcharts in FIGS. 3 and 4, is executed by the CPU 801, thereby realizing an operation control of the entire data processing apparatus 800.

The image scanner 807 corresponds to the scanner circuit 201 in FIG. 2. The storage device 808 is a large-capacity storage device, e.g., hard disk (HD), a magneto-optical disk (MD) or the like, and corresponds to the storage device 207 in FIG. 2. Assume that the storage device 808 stores the aforementioned OS 806 and the like in advance.

The disk drive 809 reads data out of a portable storage medium, e.g., a flexible disk (FD). The aforementioned control program 804, which is stored in advance in either the FD set in the disk drive 809 or the storage device 808, is read out by the CPU 801 and stored in an executable form in the RAM 803.

The VRAM 810 is provided for developing a bitmap image to be displayed on a screen. The display unit 811 displays the bitmap image developed in the VRAM 810.

The keyboard 812 is provided for inputting various data. The pointing device 813 is provided for a user to designate a desired position on the screen of the display unit 811, or to select a desired menu from various menus, e.g., a menu panel. In accordance with respective inputs of the keyboard 812 and pointing device 813, the CPU 801 performs an operation control of the entire data processing apparatus 800.

The printer 814 corresponds to the printer device 202 in FIG. 2. The printer 814 prints an image or the like, read by the image scanner 807.

The network circuit 815 corresponds to the network circuit 203 in FIG. 2. By virtue of the network circuit 815, the data processing apparatus can be connected with other host computers through a LAN or the like. For instance, image data transferred by another host computer can be subjected to resolution conversion by the CPU 801 executing software processing.

<Other Embodiment>

The present invention can be applied to a data processing method of an image processing apparatus comprising a single device, such as that shown in FIGS. 2, 5, and 6, or to a system constituted by a plurality of devices.

Further, the object of the present invention can also be achieved by providing a storage medium (recording medium), storing program codes of software realizing the above-described functions of the embodiments as a host or a terminal, to a computer system or apparatus, reading the program codes, by a CPU or MPU of the computer system or apparatus, from the storage medium, then executing the program. In this case, the program codes read from the storage medium realize the functions according to the embodiments, and the storage medium storing the program codes constitutes the invention.

The storage medium, such as ROM, a flexible disk, hard disk, an optical disk, a magneto-optical disk, CD-ROM, CD-R, a magnetic tape, and a non-volatile type memory card, can be used for providing the program codes. Furthermore, besides aforesaid functions according to the above embodiments are realized by executing the program codes which are read by a computer, the present invention includes a case where an OS (operating system) or the like working on the computer performs a part or the entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, a CPU or the like contained in the function expansion card or unit performs a part or the entire processes in accordance with designations of the program codes and realizes functions of the above embodiments.

As has been set forth above, according to the present invention, it is possible to assure prevention of input/output of image data, which is identical to a particular image, to/from an external apparatus such as a host computer. Therefore, it is possible to assure forgery prevention of securities, paper money and so forth, using copying machines or the like.

The present invention is not limited to the above embodiment and various changes and modifications can be made within the spirit and scope of the present invention. Therefore, to apprise the public of the scope of the present invention, the following claims are made.

What is claimed is:

1. An image processing apparatus comprising:
receiving means for receiving a control command related to processing of image data from an external apparatus;
image processing means for processing the image data;
identifying means for identifying whether or not driver software installed in the external apparatus has a forgery prevention function of image data; and
control means for controlling said image processing means to process the image data based on the control command in a case where it is identified that the driver software has a forgery prevention function, while controlling said image processing means to process the image data under a predetermined condition in a case where it is identified that the driver software does not have a forgery prevention function.

2. The image processing apparatus according to claim 1, further comprising input means for inputting the image data from the external apparatus, or output means for outputting image data processed by said image processing means to the external apparatus.

3. An image processing apparatus comprising:
input means for inputting image data;
receiving means for receiving a setting related to a resolution of the image data from an external apparatus;
resolution conversion means for converting the resolution of the image data;
identifying means for identifying whether or not driver software installed in the external apparatus has a forgery prevention function of image data; and
control means for controlling said resolution conversion means to perform resolution conversion of the image data based on the setting related to the resolution in a case where it is identified that the driver software has a forgery prevention function, while controlling said resolution conversion means to perform resolution conversion of the image data under a predetermined condition in a case where it is identified that the driver software does not have a forgery prevention function.

4. The image processing apparatus according to claim 3, further comprising output means for outputting the resolution-converted image data to the external apparatus.

5. The image processing apparatus according to claim 1, wherein the forgery prevention function is a function for preventing forgery by detecting specific digital watermark information in the image data, or a function for preventing forgery by calculating a similarity level between a characteristic obtained from the image data and a characteristic of a particular image set in advance.

6. The image processing apparatus according to claim 1, wherein said identifying means identifies an existence/absence of the forgery prevention function of image data by determining whether or not the driver software is a genuine driver software for the external apparatus.

7. The image processing apparatus according to claim 1, wherein said identifying means identifies an existence/absence of a forgery prevention function of image data based on version information of the driver software.

8. The image processing apparatus according to claim 1, wherein in a case where it is identified that the driver software does not have a forgery prevention function, said control means controls said image processing means to restrain an image quality of the image data.

9. The image processing apparatus according to claim 8, wherein the restraint of the image quality of the image data is a restraint of a resolution.

10. The image processing apparatus according to claim 8, further comprising display means for displaying a message of a restrained image quality of the image data.

11. The image processing apparatus according to claim 1, further comprising window display means for displaying a warning message on a window or printing means for printing the warning message, in a case where it is identified that the driver software does not have a forgery prevention function.

12. A control method of an image processing apparatus having image processing means for processing image data, comprising:
a receiving step of receiving a control command related to processing of the image data from an external apparatus;
an identifying step of identifying whether or not driver software installed in the external apparatus has a forgery prevention function of image data; and
a control step of controlling the image processing means to process the image data based on the control command in a case where it is identified that the driver software has a forgery prevention function, while controlling the image processing means to process the image data under a predetermined condition in a case where it is identified that the driver software does not have a forgery prevention function.

13. The control method of an image processing apparatus according to claim 12, further comprising an input step of inputting the image data from the external apparatus, or an output step of outputting image data processed by the image processing means to the external apparatus.

14. A control method of an image processing apparatus having resolution conversion means for converting a resolution of inputted image data, comprising:
an input step of inputting the image data;
a receiving step of receiving a setting related to a resolution of the image data from an external apparatus;
an identifying step of identifying whether or not driver software installed in the external apparatus has a forgery prevention function of image data; and
a control step of controlling the resolution conversion means to perform resolution conversion of the image data based on the setting related to the resolution in a case where it is identified that the driver software has a forgery prevention function, while controlling the resolution conversion means to perform resolution conversion of the image data under a predetermined condition in a case where it is identified that the driver software does not have a forgery prevention function.

15. The control method of an image processing apparatus according to claim 14, further comprising an output step of outputting the resolution-converted image data to the external apparatus.

16. The control method of an image processing apparatus according to claim 12, wherein the forgery prevention function is a function for preventing forgery by detecting specific digital watermark information in the image data, or a function for preventing forgery by calculating a similarity level between a characteristic obtained from the image data and a characteristic of a particular image set in advance.

17. The control method of an image processing apparatus according to claim 12, wherein in said identifying step, an existence/absence of the forgery prevention function of image data is identified by determining whether or not the driver software is a genuine driver software for the external apparatus.

18. The control method of an image processing apparatus according to claim 12, wherein in said identifying step, an existence/absence of a forgery prevention function of image data is identified based on version information of the driver software.

19. The control method of an image processing apparatus according to claim 12, wherein in a case where it is identified that the driver software does not have a forgery prevention function, said control step controls the image processing means to restrain an image quality of the image data.

20. The control method of an image processing apparatus according to claim 19, wherein the restraint of the image quality of the image data is a restraint of a resolution.

21. The control method of an image processing apparatus according to claim 19, further comprising a display step of displaying a message of a restrained image quality of the image data.

22. The control method of an image processing apparatus according to claim 12, further comprising a window display step of displaying a warning message on a window or a printing step of printing the warning message, in a case where it is identified that the driver software does not have a forgery prevention function.

23. A program executed by a computer which is connectable to image processing means for processing image data, said program causing the computer to execute:
a receiving procedure for receiving a control command related to processing of the image data from an external apparatus;
an identifying procedure for identifying whether or not driver software installed in the external apparatus has a forgery prevention function of image data; and
a control procedure for controlling the image processing means to process the image data based on the control command in a case where it is identified that the driver software has a forgery prevention function, while controlling the image processing means to process the image data under a predetermined condition in a case where it is identified that the driver software does not have a forgery prevention function.

24. A program executed by a computer which is connectable to resolution conversion means for converting a resolution of inputted image data, said program causing the computer to execute:
a receiving procedure for receiving a setting related to a resolution of the image data from an external apparatus;
an identifying procedure for identifying whether or not driver software installed in the external apparatus has a forgery prevention function of image data; and
a control procedure for controlling the resolution conversion means to perform resolution conversion of the image data based on the setting related to the resolution in a case where it is identified that the driver software has a forgery prevention function, while controlling the resolution conversion means to perform resolution conversion of the image data under a predetermined condition in a case where it is identified that the driver software does not have a forgery prevention function.

25. A computer-readable recording medium storing the program described in claim 23.
